(19) United States
(12) Patent Application Publication
(10) Pub. No.: US 2022/0255338 A1
(43) Pub. Date: Aug. 11, 2022

(54) Vehicle Charging Device and Method for the Same

(71) Applicants: Hyundai Motor Company, Seoul (KR); Kia Corporation, Seoul (KR)

(72) Inventors: Jungmo Yu, Seoul (KR); Jung Hwi Kim, Hwaseong-si (KR); Yong Jae Lee, Yongin-si (KR); Jae Ho Hwang, Daejeon (KR); Joo Young Park, Yongin-si (KR); Jae Hyeon Park, Seoul (KR)

(21) Appl. No.: 17/570,514

(22) Filed: Jan. 7, 2022

(30) Foreign Application Priority Data
Feb. 8, 2021 (KR) 10-2021-0017535

(51) Int. Cl. H02J 7/00; B60L 53/14

(52) U.S. Cl. CPC H02J 7/007188; H02J 7/0049; B60Y 2200/91; H02J 7/00041; B60L 53/14; H02J 7/00034

(57) ABSTRACT

An embodiment vehicle charging device includes a battery, an inverter electrically connected to the battery, a communicator configured to communicate with a constituent element included in a vehicle, and a controller configured to identify whether a person is present within a predetermined reference distance range from the vehicle based on signals received through the communicator during charging of the battery and to adjust a switching frequency of the inverter such that a voltage supplied to the battery is converted based on the identification result indicating presence or absence of the person within the predetermined reference distance range.

### CROSS-REFERENCE TO RELATED APPLICATIONS

This application claims the benefit of Korean Patent Application No. 10-2021-0017535, filed on Feb. 8, 2021, which application is hereby incorporated herein by reference.

### TECHNICAL FIELD

Embodiments of the present disclosure relate to a vehicle charging device and a method for the same.

### BACKGROUND

A conventional vehicle charging device may combine electric vehicle supply equipment (EVSE), an interior permanent magnet synchronous motor (IPMSM), and an inverter with one another, so that the conventional vehicle charging device can use the combined structure as a battery charging circuit.

A multiple-input charging device including multiple input terminals may perform voltage transformation through inverter switching, and may utilize the transformed voltage for charging.

From among conventional vehicle charging devices, a fast charging device need not perform inverter switching, and a slow charging device performs switching at a very high frequency so that noise problems may not occur in the slow charging device. The multiple-input fast charging device may perform inverter switching in an audible frequency band, so that the multiple-input fast charging device is vulnerable to such noise problems.

In relation to a switching frequency configured when an input voltage of the multiple-input charging device is transformed, as the switching frequency is adjusted, there occurs a tradeoff relationship between charging efficiency and such noise issues. When the switching frequency is high, the noise issues can be solved, but there is a disadvantage in that the charging efficiency decreases due to an increase in switching loss. Conversely, when the switching frequency is low, the charging efficiency is excellent, but when the switching frequency enters the audible frequency band, serious noise may occur.

### SUMMARY

Therefore, an embodiment of the present disclosure provides a vehicle charging device and a method for the same, which can vary a switching frequency of an inverter depending on various situations by considering that charging efficiency and the noise issue conflict with each other according to a switching frequency of an inverter of a conventional vehicle charging device.

Another embodiment of the present disclosure provides a vehicle charging device and a method for the same, which can minimize noise in a situation where charging efficiency of a vehicle battery is somewhat degraded during charging of the vehicle battery, or can determine whether to increase the battery charging efficiency even if noise occurs during battery charging, so that the switching frequency of the inverter of the vehicle charging device can be adjusted according to various situations such as states of the vehicle and/or the surrounding environments of the vehicle.

In accordance with an embodiment of the present disclosure, a vehicle charging device may include a battery, an inverter electrically connected to the battery, a communicator configured to communicate with at least one of constituent elements included in a vehicle, and a controller. The controller may identify whether a person is present within a predetermined reference distance range from the vehicle based on signals received through the communicator during charging of the battery, and may adjust a switching frequency of the inverter such that a voltage supplied to the battery is converted based on the identification result indicating presence or absence of the person within the predetermined reference distance range.

The predetermined reference distance range may include at least one of inside and outside of the vehicle. The controller may identify whether the person is present in at least one of inside and outside of the vehicle, based on signals received from a sensor located in at least one of inside and outside of the vehicle through the communicator.

The controller may identify whether a state of charge (SOC) of the battery is less than a predetermined reference SOC (state of charge). The controller may adjust the switching frequency further based on information indicating that the battery SOC is less than the predetermined reference SOC.

When the person is not present within the predetermined reference distance range from the vehicle, the controller may reduce the switching frequency based on information indicating that the battery SOC is less than the predetermined reference SOC.

The controller may identify whether at least one of windows or doors of the vehicle are open or closed, based on signals received from a sensor that detects whether at least one of windows or doors of the vehicle are open or closed, through the communicator. The controller may adjust the switching frequency further based on information about whether at least one of windows or doors of the vehicle are open or closed.

The vehicle charging device may further include a storage configured to store a plurality of switching frequencies. The plurality of switching frequencies may be predetermined, based on information about the presence or absence of the person, information indicating that the battery SOC is less than the predetermined reference SOC, and information about whether at least one of windows or doors of the vehicle are open or closed. The controller may determine any one of the switching frequencies stored in the storage to be the switching frequency, based on the identification result indicating the presence or absence of the person, the identification result indicating that the battery SOC is less than the predetermined reference SOC, and the identification result indicating whether at least one of windows or doors of the vehicle are open or closed.

The controller may identify surrounding environment information of the vehicle based on the signals received through the communicator. The controller may adjust the switching frequency of the inverter further based on the surrounding environment information of the vehicle.

The vehicle surrounding environment information may include at least one of current time information, current weather information, or vehicle location information.

The vehicle charging device may further include a storage. The controller may determine any one from among values for adjusting the switching frequency in response to a plurality of surrounding environment information pre-stored in the storage, based on the surrounding environment information of the vehicle, and may calculate a sum of the determined value and the switching frequency, thereby adjusting the switching frequency using the calculated sum.

The controller may identify whether the person is present within the predetermined reference distance range from the vehicle at intervals of a predetermined time during charging of the battery.

In accordance with another embodiment of the present disclosure, a method for charging a vehicle may include identifying whether a person is present within a predetermined reference distance range from the vehicle, based on signals received through a communicator of the vehicle during charging of a battery of the vehicle, and adjusting a switching frequency of an inverter electrically connected to the battery, such that a voltage supplied to the battery is converted based on the identification result indicating presence or absence of the person within the predetermined reference distance range.

The predetermined reference distance range may include at least one of inside and outside of the vehicle. The identifying whether the person is present within the predetermined reference distance range from the vehicle may include identifying whether the person is present in at least one of inside and outside of the vehicle, based on signals received from a sensor located in at least one of inside and outside of the vehicle.

The method may further include identifying whether a state of charge (SOC) of the battery is less than a predetermined reference SOC (state of charge), and the adjusting of the switching frequency is performed further based on information indicating that the battery SOC is less than the predetermined reference SOC.

The adjusting the switching frequency may include, when the person is not present within the predetermined reference distance range from the vehicle, reducing the switching frequency based on information indicating that the battery SOC is less than the predetermined reference SOC.

The method may further include identifying whether at least one of windows or doors of the vehicle are open or closed, based on signals received from a sensor that detects whether at least one of windows or doors of the vehicle are open or closed. The adjusting of the switching frequency may be performed further based on information about whether at least one of windows or doors of the vehicle are open or closed.

The adjusting the switching frequency may include determining any one from among switching frequencies corresponding to pre-stored conditions to be the switching frequency, based on the identification result indicating the presence or absence of the person, the identification result indicating that the battery SOC is less than the predetermined reference SOC, and the identification result indicating whether at least one of windows or doors of the vehicle are open or closed.

The method may further include identifying surrounding environment information of the vehicle based on the signals received through the communicator. The adjusting the switching frequency may be performed further based on the surrounding environment information of the vehicle.

The surrounding environment information of the vehicle may include at least one of current time information, current weather information, or vehicle location information.

The adjusting the switching frequency may include determining any one from among values for adjusting the switching frequency in response to a plurality of pre-stored surrounding environment information based on the surrounding environment information of the vehicle, calculating a sum of the determined value and the switching frequency, and adjusting the switching frequency using the calculated sum.

The identifying whether the person is present within the predetermined reference distance range from the vehicle may be performed at intervals of a predetermined time during charging of the battery.

### BRIEF DESCRIPTION OF THE DRAWINGS

These and/or other embodiment of the invention will become apparent and more readily appreciated from the following description of exemplary embodiments, taken in conjunction with the accompanying drawings, in which:

FIGS. 1A and 1B are circuit diagrams illustrating a circuit of a vehicle charging device and an equivalent circuit of the vehicle charging device according to an embodiment of the present disclosure;

FIG. 2 is a block diagram illustrating a vehicle charging device for charging a battery according to an embodiment of the present disclosure;

FIG. 3 is a flowchart illustrating a method for operating the vehicle charging device according to an embodiment of the present disclosure;

FIG. 4 is a flowchart illustrating a method for operating the vehicle charging device according to an embodiment of the present disclosure; and

FIG. 5 is a flowchart illustrating a method for operating the vehicle charging device according to an embodiment of the present disclosure.

### DETAILED DESCRIPTION OF ILLUSTRATIVE EMBODIMENTS

Reference will now be made in detail to the embodiments of the present disclosure, examples of which are illustrated in the accompanying drawings, wherein like reference numerals refer to like elements throughout. It should be noted that the specification of the present disclosure does not describe all the constituent elements of the embodiments, and general matters well known to those skilled in the art and redundant matters of the embodiments will not be described herein for clarity.

Throughout the specification of the present disclosure, terms “ . . . part”, “ . . . module”, “ . . . member”, “ . . . block”, and the like mean an element capable of being implemented by hardware, software, or a combination thereof. As used in the specification and appended claims, the term “ . . . parts”, “ . . . modules”, “ . . . members”, or “ . . . blocks” may be implemented by a single constituent element, or the term “ . . . part”, “ . . . module”, “ . . . member”, or “ . . . block” may include a plurality of constituent elements.

Throughout the specification of the present disclosure, if it is assumed that a certain part is connected (or coupled) to another part, the term “connection or coupling” means that the certain part is directly connected (or coupled) to another part and/or is indirectly connected (or coupled) to another part. Here, indirect connection (or indirect coupling) may conceptually include connection (or coupling) over a wireless communication network.

Throughout the specification of the present disclosure, if it is assumed that a certain part includes a certain component, the term “comprising or including” means that a corresponding component may further include other components unless context clearly indicates otherwise.

In the description of embodiments of the present disclosure, the terms “first” and “second” may be used to describe various components, but the components are not limited by the terms. These terms may be used to distinguish one component from another component.

The terms “a”, “an”, “one”, “the” and other similar terms include both singular and plural forms, unless context clearly dictates otherwise.

Identification numbers for use in respective operations to be described later are used for convenience of description and better understanding of the present disclosure, do not describe the order or sequence of the respective operations of the present disclosure, and the respective operations of the present disclosure may be carried out in a different way from the order written in the present disclosure, unless context of each operation clearly indicates a specific order.

The principles of the present disclosure and the embodiments of the present disclosure will hereinafter be given with reference to the attached drawings. A vehicle and a method for controlling the same according to embodiments of the present disclosure will hereinafter be given with reference to the attached drawings.

Hereinafter, the principles and embodiments of the present disclosure will be described with reference to the accompanying drawings.

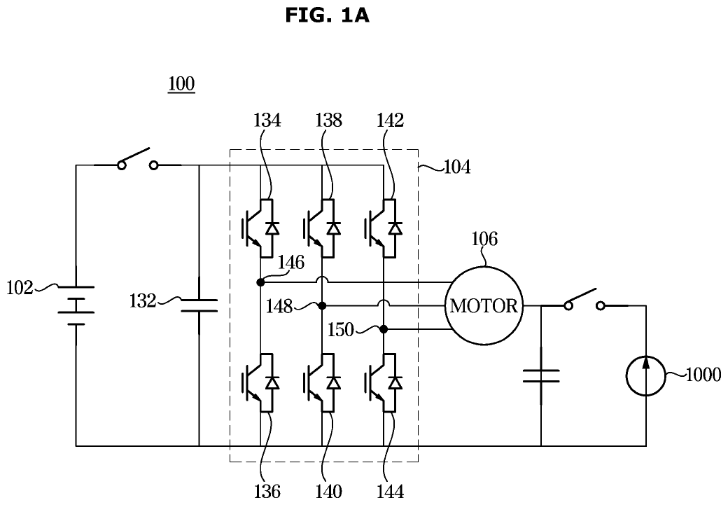

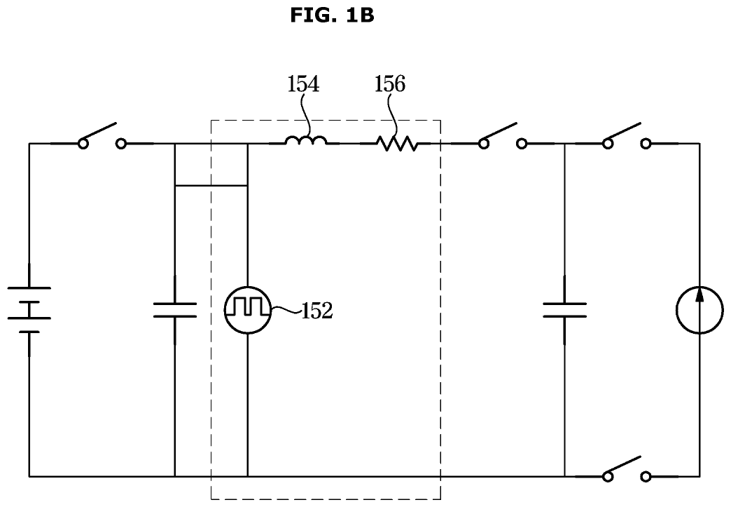

FIGS. 1A and 1B are circuit diagrams illustrating a circuit of a vehicle charging device 100 and an equivalent circuit of the vehicle charging device 100 according to an embodiment of the present disclosure.

Referring to FIGS. 1A and 1B, the vehicle charging device wo for a vehicle may charge a vehicle battery 102 through electric vehicle supply equipment (EVSE) 1000, and may include a battery 102, an inverter 104, and a motor 106.

Referring to FIG. 1A, the vehicle charging device wo may connect a capacitor 132 and the inverter 104 to both ends of the battery 102.

The inverter 104 may include a plurality of switching elements, for example, first to sixth switching elements 134, 136, 138, 140, 142, and 144.

The first switching element 134 and the second switching element 136 may be connected in series. The third switching element 138 and the fourth switching element 140 may be connected in series. The fifth switching element 142 and the sixth switching element 144 may be connected in series.

A connection node 146 for interconnecting the first and second switching elements 134 and 136, a connection node 148 for interconnecting the third and fourth switching elements 138 and 140, and a connection node 150 for interconnecting the fifth and sixth switching elements 142 and 144 may be connected to the motor 106.

The circuit including the inverter 104 and the motor 106 of the vehicle charging device 100 shown in FIG. 1A may be represented by a direct current (DC) equivalent circuit including a square-wave voltage source 152, a coil 154, and a resistor 156 shown in FIG. 1B.

The square-wave voltage source 152 may generate switching frequency (Fsw) components. When the switching frequency is in the audible frequency band, serious noise may occur in the inverter 104 and the motor 106.

Human ears are most sensitive to the 3 kHz band and then gradually become insensitive to sound. As a result, when the inverter 104 performs pulse width modulation (PWM) switching, serious noise may occur.

Noise generated in the inverter 104 and the motor 106 may relate to the switching frequency (also referred to as a PWM switching frequency) of the inverter 104, and the switching frequency of the inverter 104 may relate to the charging efficiency of the battery 102.

For example, when the switching frequency of the inverter 104 is adjusted downward, the noise issue may seriously occur, but the charging efficiency of the battery 102 may increase. Conversely, when the switching frequency of the inverter 104 is adjusted upward, less noise may occur, resulting in reduction in charging efficiency of the battery 102.

For example, the inner area of a hysteresis curve of a magnetic body may refer to the iron loss associated with charging efficiency of the battery 102. As the switching frequency of the inverter 104 increases, the inner area of the hysteresis curve may increase, thereby increasing the iron loss. In this case, the increase in the iron loss may refer to reduction in charging efficiency of the battery 102, so that the increase in switching frequency of the inverter 104 may denote reduction in charging efficiency of the battery 102.

The embodiments of the present disclosure provide technology for efficiently charging the battery 102 of the vehicle by changing the switching frequency of the inverter 104 according to vehicle states, situations of a vehicle driver, and the vehicle surrounding environmental situations, etc. in a situation where the charging efficiency of the battery 102 conflicts with the noise issue generated in the inverter 104 and the motor 106 according to the switching frequency of the inverter 104.

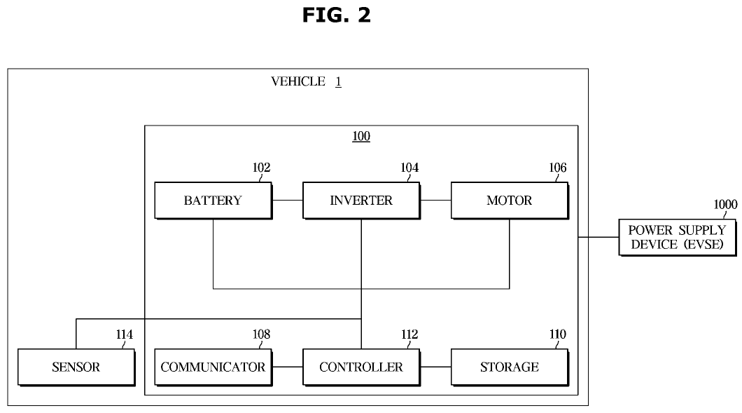

FIG. 2 is a block diagram illustrating a vehicle charging device 100 for charging the battery 102 according to an embodiment of the present disclosure.

Referring to FIG. 2, the vehicle charging device 100 may include the battery 102, the inverter 104, the motor 106, a communicator 108, a storage 110, and a controller 112.

The battery 102 may store energy therein, and may supply power to at least one constituent element (or at least one device) from among the devices included in the vehicle 1.

The inverter 104 may be electrically connected to the battery 102 and the motor 106.

The inverter 104 may receive power required to charge the battery 102 from the EVSE 1000, may perform voltage transform, may supply the transformed voltage to the battery 102, and may allow the battery 102 to be charged with electricity. The inverter 104 may perform switching based on the switching frequency such that voltage supplied to the battery 102 can be converted. For example, the inverter 104 may include the plurality of switching elements 134, 136, 138, 140, 142, and 144, and the switching elements 134, 136, 138, 140, 142, and 144 may be turned on and/or may be turned off based on the switching frequency.

The inverter 104 may convert DC power received from the battery 102 into AC power for driving the motor 106. The motor 106 may receive AC power from the inverter 104, and may thus generate rotational force. The motor 106 may provide rotational force to the drive wheels of the vehicle 1, and may also be referred to as a drive motor.

The communicator 108 may include a communication circuit (also referred to as a transceiver) configured to perform communication (e.g., CAN (controller area network) communication and/or LIN (local interconnect network) communication) between constituent elements (also referred to as devices) of the vehicle 1 through a vehicle communication network, and may further include a control circuit for controlling operation of the communication circuit.

The communicator 108 may establish a wired and/or wireless communication channel between the vehicle 1 and the external device such as an external server (not shown), may perform communication between the vehicle 1 and the external device through the communication channel, and may further include a communication circuit. For example, the communicator 108 may include a wired communication module (e.g., a powerline communication module) and/or a wireless communication module (e.g., a cellular communication module, a Wi-Fi communication module, a short-range wireless communication module, and/or a Bluetooth communication module), and may communicate with the external device using the corresponding communication module.

The storage no may store various kinds of data (for example, a software program and input/output (I/O) data for commands related to the software program) used by at least one constituent element of the vehicle 1. The storage no may include a memory, for example, a volatile memory and/or a non-volatile memory.

The controller 112 (e.g., ICU (integrated central control circuit unit) or EMS (energy management system)) may control at least one constituent element (e.g., device and/or software (software program)) of the vehicle 1, and may perform various data processing and operations.

The controller 112 may include an electronic control unit (ECU) to control a power system of the vehicle 1. The controller 112 may include a processor and a memory.

The controller 112 may control the inverter 104 to charge the battery 102. The controller 112 may determine and adjust the switching frequency of the inverter 104, and may control the switching operation of the inverter 104 based on the switching frequency, thereby converting the voltage supplied to the battery 102. The controller 112 may turn on or off the plurality of switching elements 134, 136, 138, 140, 142, and 144 included in the inverter 104 based on the switching frequency, thereby adjusting the voltage supplied to the motor 106. The controller 112 may generate a pulse width modulation (PWM) signal for controlling ON and/or OFF states of the switching elements 134, 136, 138, 140, 142, and 144 included in the inverter 104 based on the switching frequency, and may control the ON and/or OFF states of the switching elements 134, 136, 138, 140, 142, and 144 included in the inverter 104.

The controller 112 may receive signals from the sensor 114 of the vehicle 1 through the communicator 108, and may adjust the switching frequency of the inverter 104 such that the voltage supplied to the battery 102 can be converted based on the signals received from the sensor 114.

The sensor 114 may be located inside and/or outside the vehicle 1, may sense the presence or absence of a person located inside and/or outside the vehicle 1, may detect a state of charge (SOC) state indicating the charging rate of the battery 102, and may detect whether windows and/or doors of the vehicle 1 are open or closed.

For example, the sensor may include a camera, a proximity sensor, a pressure sensor, an infrared (IR) sensor, an ultrasonic sensor, a battery sensor, and/or an opening/closing sensor for sensing whether at least one of windows and/or doors of the vehicle 1 are open or closed.

The controller 112 may adjust the switching frequency of the inverter 104 based on the presence or absence of a person located inside and/or outside the vehicle 1, the result of identifying the SOC (state of charge) of the battery 102, and the result of identifying whether windows and/or doors of the vehicle 1 are open or closed.

The controller 112 may receive signals from the external server and/or the external device through the communicator 108, and may adjust the switching frequency of the inverter 104 based on signals received from the external server.

The external server may be a server configured to provide current time information and/or current weather information. The external device may be a global positioning system (GPS) satellite.

The controller 112 may adjust the switching frequency of the inverter 104 based on current time information, weather information and/or GPS information.

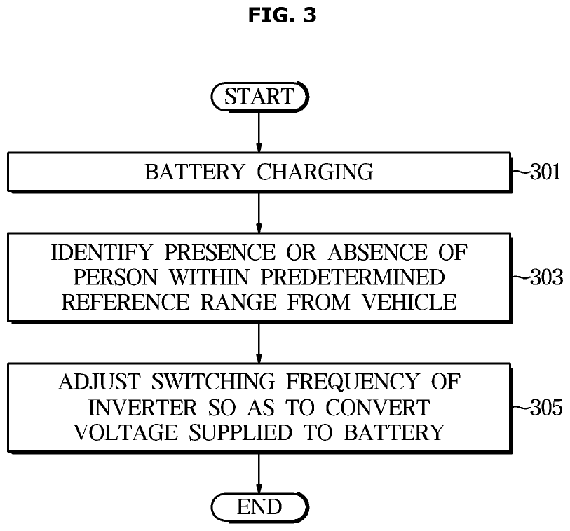

FIG. 3 is a flowchart illustrating a method for operating the vehicle charging device 100 (and/or the controller 112 of the vehicle charging device 100) according to an embodiment of the present disclosure.

Referring to FIG. 3, the vehicle charging device 100 may charge the battery 102 (301).

The vehicle charging device 100 may detect whether a person is present within a predetermined reference distance from the vehicle 1 based on signals received through the communicator 108 (303).

The vehicle charging device 100 may detect whether a person is present within a predetermined reference distance (also referred to as a predetermined reference distance range) from the vehicle 1 at intervals of a predetermined time cycle during charging of the vehicle battery 102.

The vehicle charging device 100 may determine whether the person is located inside or outside the vehicle 1 based on signals received from at least one sensor 114 that is located inside and/or outside the vehicle 1 through the communicator 108.

For example, the camera, the proximity sensor, the pressure sensor, and/or the infrared (IR) sensor, etc. may be included in the vehicle 1, so that it can be determined whether the person is located inside the vehicle 1. The ultrasonic sensor and/or the camera may be located outside the vehicle 1, so that it can be determined whether the person is located around the vehicle 1.

The vehicle charging device 100 may adjust the switching frequency of the inverter 104 (305) such that the voltage supplied to the battery 102 can be converted based on the presence or absence of the person within the predetermined reference distance from the vehicle 1.

The vehicle charging device wo may determine the switching frequency of the inverter 104 based on the identification result of the presence or absence of the person within the predetermined reference range from the vehicle 1, and may adjust the predetermined switching frequency of the inverter 104 to be the determined switching frequency.

When the person is not present within the predetermined reference range, the vehicle charging device wo may reduce the switching frequency.

In addition to the above-mentioned embodiments, the vehicle charging device 100 may identify whether the SOC of the battery 102 is less than a predetermined reference SOC. The vehicle charging device wo may adjust the switching frequency of the inverter 104 based on the fact that the SOC of the battery 102 is less than the reference SOC.

The vehicle charging device wo may determine the presence or absence of a person within the predetermined reference range from the vehicle 1, may determine whether the SOC of the battery 102 is less than the reference SOC, and may determine the switching frequency of the inverter 104 based on the result of such determination. As a result, the vehicle charging device wo may adjust the predetermined switching frequency of the inverter 104 to be the determined switching frequency.

For example, when the person is present within the predetermined reference range from the vehicle 1 and the SOC of the battery 102 is less than the predetermined SOC, the vehicle charging device 100 may reduce the switching frequency of the inverter 104.

In addition to the above-mentioned embodiments, the vehicle charging device 100 may receive signals from the sensor (that senses whether windows and/or doors of the vehicle 1 are open or closed) through the communicator 108, and may identify whether windows and/or doors of the vehicle 1 are open or closed.

The vehicle charging device 100 may adjust the switching frequency of the inverter 104 by further detecting whether windows and/or doors of the vehicle 1 are open or closed.

The vehicle charging device 100 may determine the presence or absence of the person within the predetermined reference distance from the vehicle 1, may determine whether the SOC of the battery 102 is less than the reference SOC, may determine whether windows and/or doors of the vehicle 1 are open or closed, and may thus determine the switching frequency of the inverter 104 based on the result of such determination. As a result, the vehicle charging device 100 may adjust the predetermined switching frequency of the inverter 104 to be the determined switching frequency.

The storage 110 of the vehicle charging device 100 may store a plurality of switching frequencies corresponding to predetermined conditions.

The predetermined conditions may include information about the presence or absence of the person within the predetermined reference distance from the vehicle 1, information about whether the SOC of the battery 102 is less than the reference SOC, and information about whether windows and/or doors of the vehicle 1 are open or closed.

The vehicle charging device 100 may determine any one of the switching frequencies corresponding to predetermined conditions stored in the storage no to be the switching frequency of the above-mentioned inverter 104, based on the identification result of indicating the presence or absence of the person who is located inside and/or outside the vehicle 1, the identification result of indicating whether the battery SOC is less than the reference SOC, and the identification result of indicating whether windows and/or doors of the vehicle 1 are open or closed.

In addition to the above-mentioned embodiments, the vehicle charging device 100 may identify the surrounding environment information of the vehicle 1 based on signals received from the communicator 108, and may adjust the switching frequency of the inverter 104 based on the surrounding environment information of the vehicle 1.

The surrounding environment information of the vehicle 1 may include current time information, current weather information and/or current location information of the vehicle 1.

For example, the vehicle charging device 100 may receive current time information from the external server, and may identify whether the received current time information is included in a preset daytime zone or a preset nighttime zone.

For example, the vehicle charging device 100 may receive current weather information (temperature information, humidity information, snow information, rain information, etc.) from the external server.

For example, the vehicle charging device 100 may receive a GPS signal of the vehicle 1 from the GPS satellite, and may identify current location information of the vehicle 1 based on the GPS signal of the vehicle 1. The vehicle charging device 100 may identify whether the current location information is included in a predetermined noise vulnerable region.

The storage no of the vehicle charging device 100 may store values for additionally adjusting the determined switching frequency in response to information about the predetermined surrounding environments.

The vehicle charging device 100 may calculate the sum of any one of values for adjusting a predetermined switching frequency stored in the storage no and the switching frequency determined according to the above-mentioned operation, and may correct the switching frequency using the calculated sum. In addition, the vehicle charging device 100 may determine the corrected switching frequency to be the last switching frequency, and may thus adjust the predetermined switching frequency using the corrected switching frequency.

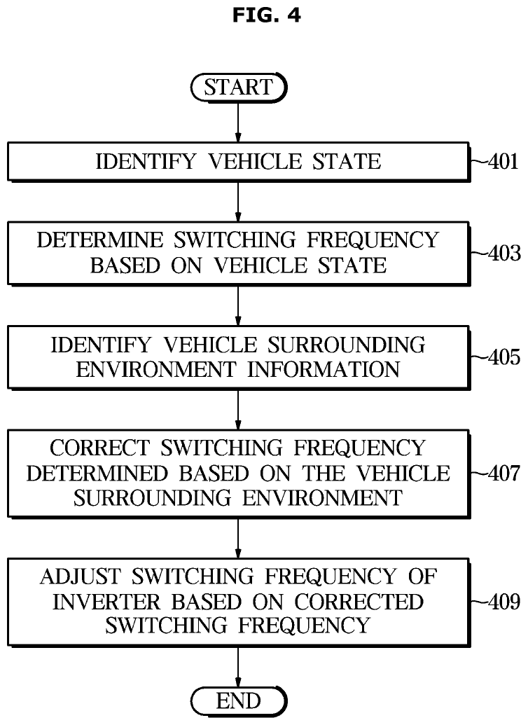

FIG. 4 is a flowchart illustrating a method for operating the vehicle charging device 100 (and/or the controller 112 of the vehicle charging device 100) according to an embodiment of the present disclosure.

Referring to FIG. 4, the vehicle charging device 100 may identify the state of the vehicle 1 during charging of the battery 102 (Operation 401).

The vehicle charging device 100 may receive the output signals from the sensor 114 of the vehicle 1, and may thus identify the state of the vehicle 1.

The state information of the vehicle 1 may include information about whether the battery SOC is less than a reference SOC, information about the presence or absence of the person located inside the vehicle 1, information about the presence or absence of the person located outside (or located around) the vehicle 1, information about whether windows of the vehicle 1 are open or closed, and/or information about whether doors of the vehicle 1 are open or closed.

The vehicle charging device 100 may determine the switching frequency of the inverter 104 based on the state information of the vehicle 1 (Operation 403).

The switching frequency of the inverter 104 determined based on the status of the vehicle 1 may be referred to as a first switching frequency (or an offset frequency). In this case, the first switching frequency may be determined to be a predetermined frequency range, for example, a frequency range from 14 kHz to 16 kHz.

The vehicle charging device 100 may determine the first switching frequency based on predetermined priority information of conditions for each state of the vehicle 1.

From among the predetermined priorities of the conditions of the vehicle states, the first priority may indicate a state of charge (SOC) of the battery 102, a second priority may indicate the presence or absence of a person located outside the vehicle 1, a third priority may indicate the presence or absence of a person located inside the vehicle 1, and a fourth priority may indicate whether windows and/or doors of the vehicle 1 are open or closed.

The fourth priority information corresponding to information about whether windows and/or doors of the vehicle 1 are open or closed may be applied to the process of determining the switching frequency of the inverter 104 only when the person is located inside the vehicle 1.

For example, the vehicle charging device 100 may determine the first switching frequency based on X values calculated by the following equation 1.

X=A+0.5B+0.2(C+0.5D) Equation 1

In Equation 1, A is set to ‘1’ when the battery SOC is less than 10%. A is set to zero ‘0’ when the battery SOC is equal to or higher than 10%. B is set to ‘1’ when the person is located outside the vehicle 1. B is set to zero ‘0’ when the person is not located outside the vehicle 1. C is set to ‘1’ when the person is located inside the vehicle 1. C is set to zero ‘0’ when the person is not located inside the vehicle 1. D is set to ‘1’ when windows and/or doors of the vehicle 1 are open. D is set to zero ‘0’ when windows and/or doors of the vehicle 1 are closed.

The storage 110 of the vehicle charging device 100 may pre-store the switching frequencies respectively corresponding to the ranges of X values depicted in the following Table 1.

TABLE 1

| X values | First switching frequency | |
|---|---|---|
| Less than 0.2 | 14.5 | kHz |
| 0.2 or more and less than 0.3 | 15 | kHz |
| 0.3 or more and less than 0.5 | 15.5 | kHz |
| 0.5 or more and less than 1 | 16 | kHz |
| 1 or more | 14 | kHz |

The vehicle charging device 100 may determine the first switching frequency based on not only the switching frequency corresponding to each of the X values depicted in Table 1, but also X values calculated through the above-mentioned equation 1.

For example, the storage no of the vehicle charging device 100 may pre-store the switching frequencies respectively corresponding to conditions for each state of the vehicle 1 as shown in the following Table 2.

TABLE 2

| | | | Case where | Case where | |
|---|---|---|---|---|---|
| | | | person is | person is | |
| | | | located | not located | |
| | | | outside | outside | |
| Conditions of states of Vehicle 1 | | | Vehicle 1 | Vehicle 1 | |
| Case where | Case where | Case where | 14 kHz | | |
| SOC of | windows | person is | | | |
| Battery 102 | and/or doors | located inside | | | |
| is equal to | of Vehicle | Vehicle 1 | | | |
| or less than | 1 are open | Case where | | | |
| Reference | | person is not | | | |
| SOC | | located outside | | | |
| | | Vehicle 1 | | | |
| | Case where | Case where | | | |
| | windows | person is | | | |
| | and/or doors | located inside | | | |
| | of Vehicle | Vehicle 1 | | | |
| | 1 are closed | Case where | | | |
| | | person is not | | | |
| | | located inside | | | |
| | | Vehicle 1 | | | |
| Case where | Case where | Case where | 16 kHz | 15.5 | kHz |
| SOC of | windows | person is | | | |
| Battery 102 | and/or doors | located inside | | | |
| is higher | of Vehicle | Vehicle 1 | | | |
| than | 1 are open | Case where | 16 kHz | 14.5 | kHz |
| Reference | | person is not | | | |
| SOC | | located inside | | | |
| | | Vehicle 1 | | | |
| | Case where | Case where | 16 kHz | 15 | kHz |
| | windows | person is | | | |
| | and/or doors | located inside | | | |
| | of Vehicle | Vehicle 1 | | | |
| | 1 are closed | Case where | 16 kHz | 14.5 | kHz |
| | | person is not | | | |
| | | located inside | | | |
| | | Vehicle 1 | | | |

The vehicle charging device 100 may identify the switching frequency appropriate for the vehicle state identified in the above operation 401 from among the switching frequencies corresponding to conditions of the vehicle states stored in the storage 110, and may determine the first switching frequency of the inverter 104 based on the identified result.

Referring to Table 2, when the battery SOC is equal to or less than a reference SOC, the vehicle charging device 100 may determine the first switching frequency to be 14 kHz, regardless of conditions of vehicle states other than the battery SOC.

For example, when the person is not located inside or outside the vehicle 1 and the SOC of the battery 102 is equal to or less than 10%, the first switching frequency can be reduced to maximize the battery SOC.

The vehicle charging device 100 may identify the surrounding environment information of the vehicle 1 (Operation 405).

The vehicle charging device 100 may receive signals from the external server and/or the external device, and may identify the surrounding environment information of the vehicle 1.

The surrounding environment information of the vehicle 1 may include current time information, weather information and/or location information of the vehicle 1.

The vehicle charging device 100 may correct the switching frequency determined in operation 403, based on the surrounding environment information (Operation 407).

The corrected switching frequency indicating the result of correcting the switching frequency determined in operation 403 may be referred to as the last switching frequency.

The last switching frequency may be determined to be any value selected from among frequency values between one frequency (e.g., 20 kHz) corresponding to a predetermined minimum SOC of the battery 102 and another frequency (e.g., 10 kHz) corresponding to a predetermined maximum noise value.

The value for correcting the switching frequency may be determined to be any one of frequency values from among predetermined frequency correction ranges (e.g., −2 kHz to +4 kHz).

The storage 110 of the vehicle charging device 100 may pre-store values for adjusting the switching frequency in response to conditions of the surrounding environment information of the vehicle 1 as shown in the following Table 3 and Table 4.

TABLE 3

| Conditions according to surrounding | Values for correcting |
|---|---|
| environment information of Vehicle 1 | the switching frequency |
| Location information of Vehicle 1 = | +2 kHz |
| Region pre-designated as noise-vulnerable | |
| region | |
| Location information of Vehicle 1 is not | 0 |
| pre-designated as noise-vulnerable region | |

TABLE 4

| | Current time | Current time |
|---|---|---|
| | information = daytime | information = nighttime |
| Weather information = | 0 | +2 kHz |
| rainy and/or snowy | | |
| Weather information = | −2 kHz | +1 kHz |
| Sunny | | |

The vehicle charging device 100 may identify values corresponding to the surrounding environment information identified in operation 405, from among values for adjusting the switching frequency corresponding to conditions of the vehicle surrounding environment information stored in the storage 110.

The vehicle charging device 100 may calculate the sum of the switching frequency determined in operation 403 and values appropriate for the identified surrounding environment information, and may correct the switching frequency based on the calculated sum. The corrected switching frequency may be referred to as the last switching frequency.

For example, when the current time information is night, the noise issues may become more serious, the first switching frequency may be corrected to be higher by 1 kHz or 2 kHz, so that the final switching frequency can be determined based on the corrected first switching frequency.

The vehicle charging device 100 may adjust the switching frequency of the inverter 104 based on the corrected switching frequency (Operation 409).

The above-mentioned operations may be repeatedly performed at intervals of a predetermined time, until the battery 102 of the vehicle 1 is completely charged with the predetermined electric charge.

In addition to the above-mentioned embodiments, when the battery SOC identified in operation 401 is less than a predetermined reference SOC, an alarm message (or alarm sound) for warning that the battery SOC is too low can be output.

In addition, values stored in the storage no may be changed to other values according to other embodiments.

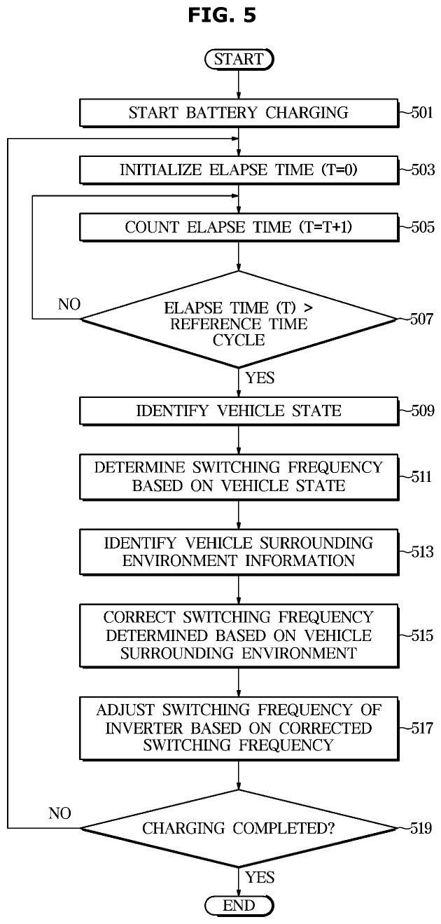

FIG. 5 is a flowchart illustrating a method for operating the vehicle charging device 100 (and/or the controller 112 of the vehicle charging device 100) according to an embodiment of the present disclosure.

Referring to FIG. 5, the vehicle charging device 100 may start charging of the battery 102 (Operation 501).

The vehicle charging device 100 may control the ON and/or OFF operations of the switching elements 134, 136, 138, 140, 142, and 144 of the inverter 104 based on either a predetermined switching frequency or a switching frequency to be adjusted in operation 515, so that the battery 102 can be charged with electricity by the vehicle charging device 100.

The vehicle charging device 100 may initialize the time (T) required to charge the battery 102 as denoted by ‘T=0’ (Operation 503).

The vehicle charging device 100 may count the time required to charge the battery 102 as denoted by ‘T=T+1’ (Operation 505).

The vehicle charging device 100 may identify whether the time (T) required to charge the battery 102 is longer than a predetermined reference time cycle (Operation 507).

The vehicle charging device 100 may identify the vehicle state and/or the vehicle surrounding environment information at intervals of a predetermined reference time during charging of the battery 102. In order to efficiently control battery charging according to the vehicle state and/or the vehicle surrounding environment information, the vehicle charging device 100 may identify whether the time required for battery charging is longer than a predetermined reference time cycle.

When the time required for battery charging is longer than the predetermined reference time cycle, the vehicle charging device 100 may perform operation 509. When the time required for battery charging is equal to or shorter than the predetermined reference time cycle, the vehicle charging device 100 may again perform operation 505.

The vehicle charging device 100 may identify the state of the vehicle 1 during charging of the battery 102 (Operation 509).

The vehicle charging device 100 may determine the switching frequency of the inverter 104 based on the vehicle state (Operation 511).

The vehicle charging device 100 may identify the surrounding environment information of the vehicle 1 (Operation 513).

The vehicle charging device 100 may correct the switching frequency determined in operation 511 based on the surrounding environment information of the vehicle 1 (Operation 515).

The vehicle charging device 100 may adjust the switching frequency of the inverter 104 based on the corrected switching frequency (Operation 517).

The above-mentioned operations 509 to 517 shown in FIG. 5 may correspond to operations 401 to 409 shown in FIG. 4, respectively, and as such a detailed description thereof will herein be omitted for convenience of description.

The vehicle charging device 100 may identify whether the battery 102 is completely charged with electricity (Operation 519).

When the battery 102 is completely charged with electricity, the vehicle charging device 100 may stop operation. When the battery 102 is incompletely charged with electricity, the vehicle charging device 100 may again perform operation 503.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be a Read Only Memory (ROM), a Random Access Memory (RAM), a magnetic tape, a magnetic disc, flash memory, an optical data storage, etc.

As is apparent from the above description, the vehicle charging device and the method for the same according to the embodiments of the present disclosure can maximize the battery charging efficiency of the vehicle in consideration of the inside and outside of the vehicle and the vehicle surrounding environment.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A vehicle charging device comprising:
a battery;
an inverter electrically connected to the battery;
a communicator configured to communicate with a constituent element included in a vehicle; and
a controller configured to:
identify whether a person is present within a predetermined reference distance range from the vehicle based on signals received through the communicator during charging of the battery; and
adjust a switching frequency of the inverter such that a voltage supplied to the battery is converted based on the identification result indicating presence or absence of the person within the predetermined reference distance range.

2. The vehicle charging device according to claim 1, wherein:
the predetermined reference distance range includes a range inside or outside the vehicle; and
the controller is configured to identify whether the person is present inside or outside the vehicle based on signals received from a sensor located inside and outside the vehicle through the communicator.

3. The vehicle charging device according to claim 1, wherein the controller is configured to:
identify whether a state of charge (SOC) of the battery is less than a predetermined reference SOC; and
adjust the switching frequency further based on information indicating that the battery SOC is less than the predetermined reference SOC.

4. The vehicle charging device according to claim 3, wherein when the person is not present within the predetermined reference distance range from the vehicle, the controller is configured to reduce the switching frequency based on information indicating that the battery SOC is less than the predetermined reference SOC.

5. The vehicle charging device according to claim 3, wherein the controller is configured to:
identify whether a window or a door of the vehicle is open or closed based on signals received from a sensor that detects whether the window or the door of the vehicle is open or closed through the communicator; and
further adjust the switching frequency based on information about whether the window or the door of the vehicle is open or closed.

6. The vehicle charging device according to claim 5, further comprising a memory configured to store a plurality of predetermined switching frequencies, wherein:
the plurality of switching frequencies is predetermined based on information about the presence or absence of the person, information indicating that the battery SOC is less than the predetermined reference SOC, and information about whether the window or the door of the vehicle is open or closed; and
the controller is configured to determine any one of the switching frequencies stored in the memory to be the switching frequency based on the identification result indicating the presence or absence of the person, the identification result indicating that the battery SOC is less than the predetermined reference SOC, and the identification result indicating whether the window or the door of the vehicle is open or closed.

7. The vehicle charging device according to claim 1, wherein the controller is configured to:
identify surrounding environment information of the vehicle based on the signals received through the communicator; and
adjust the switching frequency of the inverter further based on the surrounding environment information of the vehicle.

8. The vehicle charging device according to claim 7, wherein the vehicle surrounding environment information includes current time information, current weather information, or vehicle location information.

9. The vehicle charging device according to claim 7, further comprising a memory, wherein the controller is configured to determine any one from among values for adjusting the switching frequency in response to a plurality of surrounding environment information pre-stored in the memory based on the surrounding environment information of the vehicle, calculate a sum of the determined value and the switching frequency, and adjust the switching frequency using the calculated sum.

10. The vehicle charging device according to claim 1, wherein the controller is configured to identify whether the person is present within the predetermined reference distance range from the vehicle at intervals of a predetermined time during charging of the battery.

11. A method for charging a vehicle, the method comprising:
identifying whether a person is present within a predetermined reference distance range from the vehicle based on signals received through a communicator of the vehicle during charging of a battery of the vehicle; and
adjusting a switching frequency of an inverter electrically connected to the battery such that a voltage supplied to the battery is converted based on the identification result indicating presence or absence of the person within the predetermined reference distance range.

12. The method according to claim 11, wherein:
the predetermined reference distance range includes inside or outside the vehicle; and
identifying whether the person is present within the predetermined reference distance range from the vehicle includes identifying whether the person is present inside or outside the vehicle based on signals received from a sensor located inside or outside the vehicle.

13. The method according to claim 11, further comprising:
identifying whether a state of charge (SOC) of the battery is less than a predetermined reference SOC; and
further adjusting the switching frequency based on information indicating that the battery SOC is less than the predetermined reference SOC.

14. The method according to claim 13, wherein further adjusting the switching frequency includes reducing the switching frequency based on information indicating that the battery SOC is less than the predetermined reference SOC when the person is not present within the predetermined reference distance range from the vehicle.

15. The method according to claim 13, further comprising:
identifying whether a window or a door of the vehicle is open or closed based on signals received from a sensor that detects whether the window or the door of the vehicle is open or closed; and
further adjusting the switching frequency based on information about whether the window or the door of the vehicle is open or closed.

16. The method according to claim 15, wherein further adjusting the switching frequency includes determining any one from among switching frequencies corresponding to pre-stored conditions to be the switching frequency based on the identification result indicatiing the presence or absence of the person, the identification result indicating that the battery SOC is less than the predetermined reference SOC, and the identification result indicating whether the window or the door of the vehicle is open or closed.

17. The method according to claim 11, further comprising:
identifying surrounding environment information of the vehicle based on the signals received through the communicator; and
further adjusting the switching frequency based on the surrounding environment information of the vehicle.

18. The method according to claim 17, wherein the surrounding environment information of the vehicle includes current time information, current weather information, or vehicle location information.

19. The method according to claim 17, wherein further adjusting the switching frequency includes determining any one from among values for adjusting the switching frequency in response to a plurality of pre-stored surrounding environment information based on the surrounding environment information of the vehicle, calculating a sum of the determined value and the switching frequency, and adjusting the switching frequency using the calculated sum.

20. The method according to claim 11, wherein identifying whether the person is present within the predetermined reference distance range from the vehicle is performed at intervals of a predetermined time during charging of the battery.
